(19) United States
(12) Patent Application Publication
(10) Pub. No.: US 2026/0269951 A1
(43) Pub. Date: Sep. 10, 2026

(54) MULTI-CARRIER SIGNAL WAVEFORM EQUALIZATION CIRCUIT AND MULTI-CARRIER SIGNAL WAVEFORM EQUALIZATION METHOD

(71) Applicant: NTT, Inc., Tokyo (JP)

(72) Inventors: Kyo MINOGUCHI, Musashino-shi (JP); Etsushi YAMAZAKI, Musashino-shi (JP); Masanori NAKAMURA, Musashino-shi (JP); Kengo HORIKOSHI, Musashino-shi (JP); Seiji OKAMOTO, Musashino-shi (JP)

(73) Assignee: NTT, Inc., Tokyo (JP)

(21) Appl. No.: 18/875,525

(22) PCT Filed: Jun. 20, 2022
(86) PCT No.: PCT/JP2022/024505

§ 371 Date: Dec. 16, 2024

(51) Int. Cl. H04B 10/61; H04B 10/2513

(52) U.S. Cl. CPC H04B 10/6162; H04B 10/25133

(57) ABSTRACT

A multi-carrier signal waveform equalization circuit includes: an acquisition unit that acquires an electrical signal obtained by transforming an optical signal by coherent detection, the optical signal obtained by transformation into a digital modulation signal by phase modulation or quadrature amplitude modulation, and then the digital modulation signal being divided into a plurality of carrier waves, superimposed on local oscillation laser, and then transmitted from a transmission unit; and a crosstalk compensation unit that compensates for crosstalk between a plurality of signals superimposed on each of the plurality of carrier waves obtained from the electrical signal that has been acquired.

### TECHNICAL FIELD

The present invention relates to a multi-carrier signal waveform equalization circuit and a multi-carrier signal waveform equalization method.

### BACKGROUND ART

In coherent optical communication, polarization/phase diversity transmission/reception is realized, and digital signal processing utilizing phase information of a signal light obtained on a reception side is realized (See, for example, Non Patent Literature 1 and Non Patent Literature 2). Crosstalk and linear distortion between polarization multiplexed signals can be equalized by controlling an adaptive filter coefficient of a digital filter represented by a finite impulse response (FIR) filter.

Due to imperfection of an analog device used in a transceiver, a quadrature/amplitude error (IQ Imbalance) and a time delay difference (Skew) between In-Phase/Quadrature components of a quadrature amplitude modulation (QAM) signal exist, and crosstalk occurs between the IQ components. Similarly to the crosstalk between the polarization multiplexed signals, the crosstalk generated between the IQ components can be equalized by the adaptive filter coefficient control of the digital filter (See, for example, Non Patent Literature 3). At this time, for example, filter coefficient control for minimizing a mean square error from the reference signal can be used.

In addition, a transmission system in which a time series signal is divided into a plurality of carrier waves and transmitted and received as a multi-carrier signal is realized (See, for example, Non Patent Literature 4). In this case, the quadrature/amplitude error (IQ Imbalance) and the time delay difference (Skew) are observed as crosstalk between subcarrier signals as illustrated in FIG. 10.

### CITATION LIST

### Non Patent Literature

Non Patent Literature 1: Seb J. Savory, “Digital filters for coherent optical receivers”, Optics Express, Vol. 16, No. 2, pp. 804-817, January 2008.
Non Patent Literature 2: K. Kikuchi, “Fundamentals of Coherent Optical Fiber Communications”, Journal of Lightwave Technology, Vol. 34, No. 1, pp. 157-179, January 2016.
Non Patent Literature 3: W. Nam, H. Roh, J. Lee and I. Kang, “Blind Adaptive I/Q Imbalance Compensation Algorithms for Direct-Conversion Receivers”, IEEE Signal Processing Letters, Vol. 19, No. 8, pp. 475-478, August 2012.
Non Patent Literature 4: E. P. d. Silva and D. Zibar, “Widely Linear Blind Adaptive Equalization for Transmitter IQ-Imbalance/Skew Compensation in Multicarrier Systems”, ECOC 2016, 42nd European Conference on Optical Communications (ECOC 2016), pp. 1-3, September 2016.
Non Patent Literature 5: A. Li, Y. Zhu, W. Peng, Y. Cui and Y. Bai, “103-GBd PDM-16QAM Coherent Detection Highly Tolerant to Transmitter IQ Impairments Enabled by Real-Valued 4×4 MIMO Equalizer”, 45th European Conference on Optical Communication (ECOC 2019), September 2019.
Non Patent Literature 6: P. Skvortcov, C. Sanchez-Costa, I. Phillips and W. Forysiak, “Receiver DSP highly tolerant to transmitter IQ impairments”, Optical Fiber Communications Conference and Exhibition (OFC 2019), pp. 1-3, May 2019.
Non Patent Literature 7: Y. Fan, X. Chen, W. Zhou, X. Zhou and H. Zhu, “The Comparison of CMA and LMS Equalization Algorithms in Optical Coherent Receivers”, 6th International Conference on Wireless Communications Networking and Mobile Computing (WiCOM 2010), pp. 1-4, September 2010.

### SUMMARY OF INVENTION

### Technical Problem

According to the conventional equalization scheme, crosstalk of a signal (single carrier signal) on a single carrier wave can be equalized. However, in an environment where there are imperfections of an analog device and laser phase noise/frequency errors, the conventional equalization scheme has a problem that effective equalization cannot be performed for crosstalk between subcarriers of a multi-carrier signal.

In view of the above circumstances, an object of the present invention is to provide a multi-carrier signal waveform equalization circuit and a multi-carrier signal waveform equalization method capable of performing signal processing with higher accuracy even in an environment where imperfections of analog devices and laser phase noise/frequency errors exist in communication using multi-carrier signals.

### Solution to Problem

An aspect of the present invention is a multi-carrier signal waveform equalization circuit including: an acquisition unit that acquires an electrical signal obtained by transforming an optical signal by coherent detection, the optical signal obtained by transformation into a digital modulation signal by phase modulation or quadrature amplitude modulation, and then the digital modulation signal being divided into a plurality of carrier waves, superimposed on local oscillation laser, and then transmitted from a transmission unit; and a crosstalk compensation unit that compensates for crosstalk between a plurality of signals superimposed on each of the plurality of carrier waves obtained from the electrical signal that has been acquired.

An aspect of the present invention is a multi-carrier signal waveform equalization method including: an acquisition step of acquiring an electrical signal that is an optical signal transformed into a digital modulation signal by phase modulation or quadrature amplitude modulation, then divided into a plurality of carrier waves, superimposed on local oscillation laser, and then transmitted from a transmission unit, the optical signal being transformed by coherent detection; and a crosstalk compensation step of compensating for crosstalk between a plurality of signals superimposed on each of the plurality of carrier waves obtained from the electrical signal that has been acquired.

### Advantageous Effects of Invention

According to the present invention, in communication using a multi-carrier signal, it is possible to perform signal processing with higher accuracy even in an environment where imperfections of an analog device and a laser phase noise/frequency error exist.

### BRIEF DESCRIPTION OF DRAWINGS

FIG. 1 is an overall configuration diagram of an optical communication system 1 according to a first embodiment of the present invention.

FIG. 2 is a block diagram illustrating a configuration of a digital signal processing unit 41 according to the first embodiment of the present invention.

FIG. 3 is a diagram illustrating a configuration of a 2×2 FIR filter included in the digital signal processing unit 41 according to the first embodiment of the present invention.

FIG. 4 is a flowchart of multi-carrier signal waveform equalization processing by the digital signal processing unit 41 according to the first embodiment of the present invention.

FIG. 5 is a block diagram illustrating a configuration of a digital signal processing unit 41a according to a second embodiment of the present invention.

FIG. 6 is a diagram illustrating a procedure of a computer simulation performed.

FIG. 7 is a diagram illustrating representative parameters and values thereof used in the computer simulation performed.

FIG. 8 is a diagram illustrating a result of the computer simulation performed.

FIG. 9 is a diagram illustrating a result of the computer simulation performed.

FIG. 10 is a diagram illustrating a frequency spectrum of a multi-carrier signal.

### DESCRIPTION OF EMBODIMENTS

The present invention relates to a digital signal processing technology of a reception device in coherent optical communication. Coherent optical communication is a communication method using a property as a wave of light. Coherent means having coherence, and means that frequency or phase modulation can be used in the field of communication. Coherent optical communication is also a technology as a basis of wavelength multiplex communication that has higher reception sensitivity than an intensity modulation (IM)/direct detection (DD) system that detects a change in intensity of signal light with a photodiode and can transmit a large amount of information of terabits per second.

For example, quadrature phase shift keying (QPSK), which is one of the modulation schemes, can transmit twice as much information as the IM-DD scheme by using optical phase information. In addition, by using the property that two orthogonal optical waves do not intersect, it is possible to further transmit twice the information by placing different pieces of information on the X polarized wave and the Y polarized wave. This is called dual polarization (DP)-QPSK. In the DP-QPSK scheme, it is possible to transmit four times as much information in the same signal band as in the conventional IM-DD scheme.

The transmission unit of the optical signal transforms the digital signals of “0” and “1” into inphase (I) components and quadrature (Q) components of the X polarized wave and the Y polarized wave, respectively. The Mach-Zehnder modulator is driven by using the electrical signals of XI, XQ, YI, and YQ, and polarization combining is further performed to generate an optical signal subjected to phase modulation and polarization multiplexing.

The optical signal reception unit polarization-demultiplexes the optical signal subjected to the phase modulation and the polarization multiplexing, and then, detects the I component and the Q component in each of the X polarized wave and the Y polarized wave by interfering with a laser beam (local oscillation light) mounted on the reception unit. Since the signal light and the local light are interfered with each other to detect a signal, this is called coherent detection. The I component and the Q component of the detected X polarized wave and Y polarized wave are transformed into electrical signals by a light receiving element, and then transformed into digital sampling data by an analog to digital converter (ADC) having a high sampling rate. By performing advanced signal equalization by digital signal processing using a digital signal processor (DSP) on this data, it is possible to correct signal distortion such as wavelength dispersion and polarization dispersion peculiar to an optical fiber.

Hereinafter, a multi-carrier signal waveform equalization circuit and a multi-carrier signal waveform equalization method according to embodiments will be described with reference to the drawings.

### First Embodiment

Hereinafter, a first embodiment of the present invention will be described. A multi-carrier signal waveform equalization circuit in the first embodiment described below is a circuit that performs digital signal processing on a reception signal transformed from an optical signal into an electrical signal by coherent detection. The optical signal is transformed into a digital modulation signal by phase modulation or quadrature amplitude modulation in a transmission device as a communication partner, then divided into a plurality of carrier waves, superimposed on local oscillation laser, and then transmitted to a reception device. The multi-carrier signal waveform equalization circuit is a circuit mounted on the reception device.

The multi-carrier signal waveform equalization circuit according to the first embodiment includes a crosstalk compensation unit that compensates for crosstalk between signals superimposed on each of a plurality of carrier waves obtained from a reception signal for each polarization (that is, for each of the X-polarized wave and the Y-polarized wave). The crosstalk is a signal leaked from one channel to the other channel when a signal is transmitted through each of a plurality of channels.

With such a configuration, the multi-carrier signal waveform equalization circuit in the first embodiment can enable effective equalization for crosstalk between subcarriers in a multi-carrier signal. As a result, the multi-carrier signal waveform equalization circuit according to the first embodiment can achieve signal processing with higher accuracy even in an environment where imperfections of analog devices and laser phase noise/frequency errors exist in communication using multi-carrier signals.

### [Configuration of Optical Communication System]

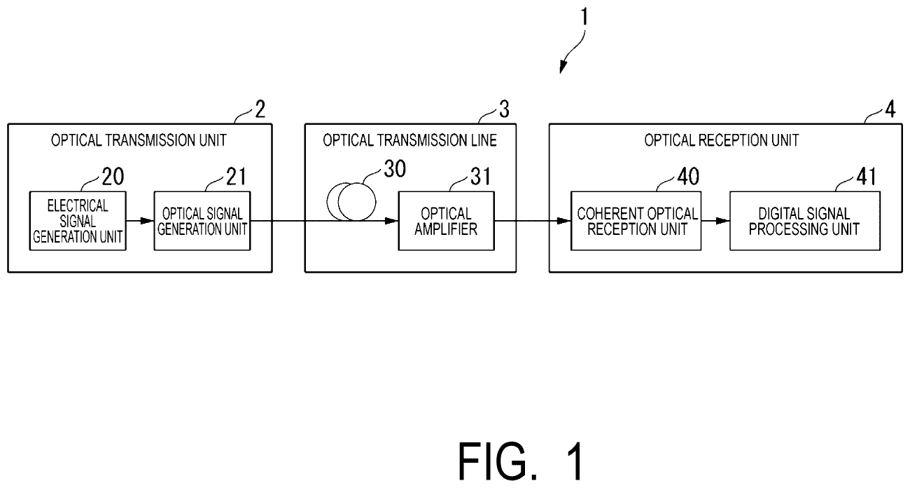

An overall configuration of an optical communication system 1 according to the first embodiment including the multi-carrier signal waveform equalization circuit described above will be described below. FIG. 1 is an overall configuration diagram of the optical communication system 1 according to the first embodiment of the present invention. As illustrated in FIG. 1, the optical communication system 1 includes an optical transmission unit 2, an optical transmission line 3, and an optical reception unit 4.

The optical transmission unit 2 includes an electrical signal generation unit 20 and an optical signal generation unit 21. The electrical signal generation unit 20 encodes information acquired from an information source (not illustrated) and transforms the information into an electrical signal waveform. The electrical signal generation unit 20 outputs the transformed electrical signal waveform to the optical signal generation unit 21. The optical signal generation unit 21 transforms the electrical signal waveform input from the electrical signal generation unit 20 into an optical signal. The optical signal generation unit 21 transmits the transformed optical signal to the optical transmission line 3.

The optical transmission line 3 includes at least an optical fiber 30. The optical fiber 30 is a transmission medium of an optical signal. The optical transmission line 3 may further include one or more optical amplifiers 31 that amplify the transmitted optical signal, for example, as illustrated in FIG. 1. Furthermore, the optical transmission line 3 may further include an optical device (not illustrated) such as an optical switch and a reproduction repeater.

The optical reception unit 4 includes a coherent optical reception unit 40 and a digital signal processing unit 41. The coherent optical reception unit 40 includes at least a 90 degree optical hybrid circuit, a local oscillation light source, a photodetector, and an optical fiber that couples these optical devices (not illustrated). As described above, the coherent optical communication is characterized in that the local oscillation light source is used on the reception side. The coherent optical reception unit 40 may further include another optical device such as an optical attenuator, for example.

The digital signal processing unit 41 includes the multi-carrier signal waveform equalization circuit described above. The configuration of the digital signal processing unit 41 will be described in detail below.

### [Configuration of Digital Signal Processing Unit]

The configuration of the digital signal processing unit 41 will be described below. In the first embodiment, as an example, a case will be described in which communication is performed using a multi-carrier signal having two subcarriers obtained by polarization multiplexing.

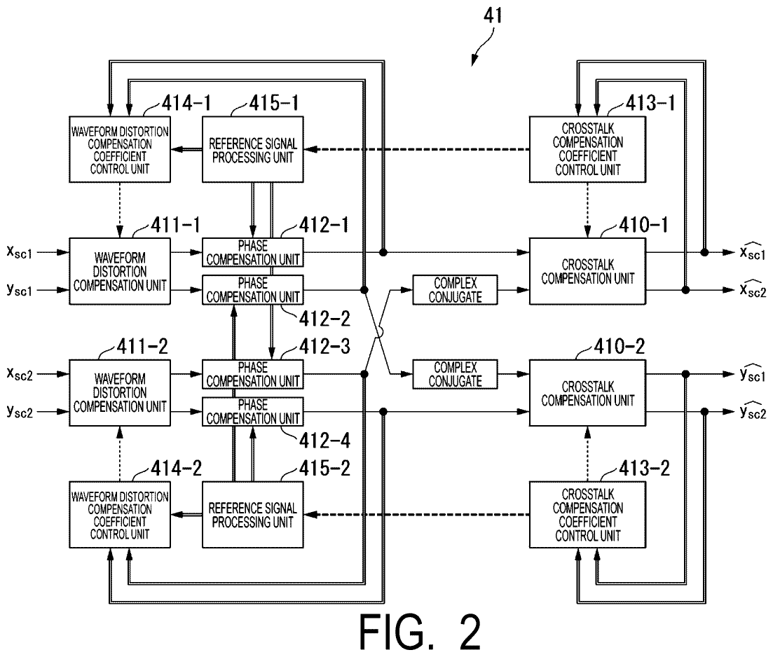

FIG. 2 is a block diagram illustrating the configuration of the digital signal processing unit 41 according to the first embodiment of the present invention. As illustrated in FIG. 2, the digital signal processing unit 41 outputs four signals of (x_{sc})\hat{ }, (y_{sc1})\hat{ }, (x_{sc2})\hat{ }, and (y_{sc2})\hat{ } in response to inputs of four signals of x_{sc1}, y_{sc1}, x_{sc2}, and y_{sc2}. These variables represent the following signals, respectively. Here, for example, a variable in which a hat symbol is assigned to the variable a is represented as “(a)\hat{ }”.
x_{sc1}: input signal (X-polarization of subcarrier #1)
y_{sc1}: input signal (Y-polarization of subcarrier #1)
x_{sc2}: input signal (X-polarization of subcarrier #2)
y_{sc2}: input signal (Y-polarization of subcarrier #2)
(x_{sc1})\hat{ }: output signal (X-polarization of subcarrier #1)
(y_{sc1})\hat{ }: output signal (Y-polarization of subcarrier #1)
(x_{sc2})\hat{ }: output signal (X-polarization of subcarrier #2)
(y_{sc2})\hat{ }: output signal (Y-polarization of subcarrier #2)

As illustrated in FIG. 2, the digital signal processing unit 41 includes a crosstalk compensation unit 410-1 and a crosstalk compensation unit 410-2, a waveform distortion compensation unit 411-1 and a waveform distortion compensation unit 411-2, a phase compensation unit 412-1 to a phase compensation unit 412-4, a crosstalk compensation coefficient control unit 413-1 and a crosstalk compensation coefficient control unit 413-2, a waveform distortion compensation coefficient control unit 414-1 and a waveform distortion compensation coefficient control unit 414-2, a reference signal processing unit 415-1, and a reference signal processing unit 415-2.

The crosstalk compensation unit 410-1 and the crosstalk compensation unit 410-2 compensate for crosstalk between signals superimposed on the subcarrier #1 and the subcarrier #2, respectively. Hereinafter, in a case where it is not necessary to distinguish and describe the crosstalk compensation unit 410-1 and the crosstalk compensation unit 410-2, they are simply referred to as “crosstalk compensation unit 410”. The crosstalk compensation unit 410 is configured using a digital filter represented by an FIR filter.

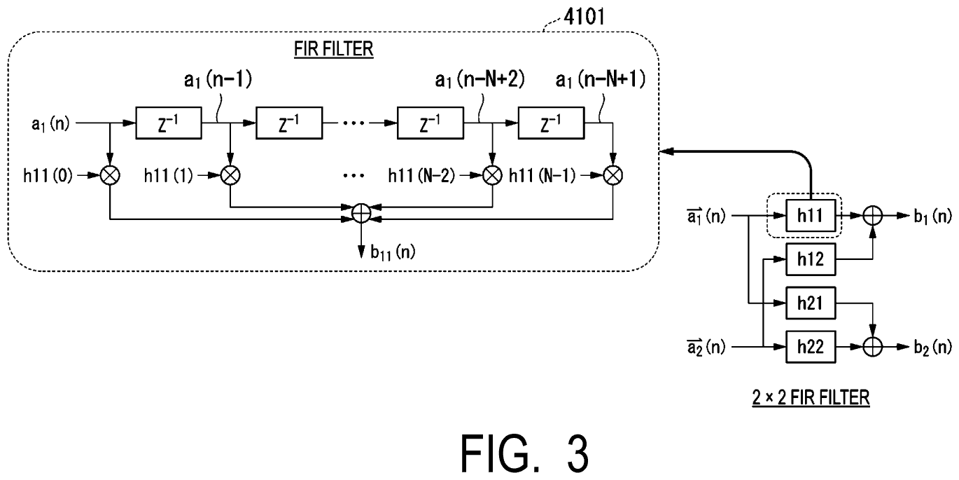

FIG. 3 is a diagram illustrating a configuration of a 2×2 FIR filter included in the digital signal processing unit 41 according to the first embodiment of the present invention. As illustrated in FIG. 3, the crosstalk compensation unit 410 in the first embodiment is configured using a 2×2 FIR filter including four FIR filters 4101.

The variables illustrated in FIG. 3 represent the following variables.
aⱼ(n): input sample of the FIR filter at time n
bᵢⱼ(n): output sample of the FIR filter at time n
hᵢⱼ(k): FIR filter coefficient (k=0, 1, . . . , N−1)
N: the number of taps of the FIR filter

Each input/output of the FIR filter is expressed as follows.

$$\begin{matrix}[ Math . 1 ] & \\ \vec{{a}_{j}} ( n ) = [ {a}_{j} ( n ) , {a}_{j} ( n - 1 ) , … , {a}_{j} ( n - N + 1 ) ] & ( 1 )\end{matrix}$$

$$\begin{matrix}[ Math . 2 ] & \\ {b}_{ij} ( n ) = {\sum }_{k = 0}^{N - 1} {a}_{j} ( n - k ) \cdot {h}_{ij} ( k ) & ( 2 )\end{matrix}$$

$$\begin{matrix}[ Math . 3 ] & \\ {b}_{1} ( n ) = {b}_{11} ( n ) + {b}_{12} ( n ) & ( 3 )\end{matrix}$$

$$\begin{matrix}[ Math . 4 ] & \\ {b}_{2} ( n ) = {b}_{21} ( n ) + {b}_{22} ( n ) & ( 4 )\end{matrix}$$

Although only the configuration of the FIR filter 4101 of h11 is illustrated in FIG. 3, the configuration of the FIR filter 4101 of h12, h21, and h22 is similar to the configuration of the FIR filter 4101 of h11. Description will be made below with reference to FIG. 2 again.

The waveform distortion compensation unit 411-1 compensates for linear distortion other than distortion to be compensated by the crosstalk compensation unit 410-1. As similar to this, the waveform distortion compensation unit 411-2 compensates for linear distortion other than distortion to be compensated by the crosstalk compensation unit 410-2. Hereinafter, in a case where it is not necessary to distinguish and describe the waveform distortion compensation unit 411-1 and the waveform distortion compensation unit 411-2, they are simply referred to as “waveform distortion compensation unit 411”. The waveform distortion compensation unit 411 is configured using a digital filter. As similar to the crosstalk compensation unit 410, the waveform distortion compensation unit 411 according to the first embodiment is configured using a 2×2 FIR filter illustrated in FIG. 3.

The phase compensation unit 412-1 to the phase compensation unit 412-4 compensate for the phase rotation of the signal using the reference signal known on the reception side. The phase rotation of the signal is caused by, for example, phase noise of the transceiver or the like. As illustrated in FIG. 2, in the first embodiment, the phase compensation unit 412-1 and the phase compensation unit 412-3 are arranged in a preceding stage of the crosstalk compensation unit 410-1, and the phase compensation unit 412-2 and the phase compensation unit 412-4 are arranged in a preceding stage of the crosstalk compensation unit 410-2. Hereinafter, in a case where it is not necessary to distinguish and describe each of the phase compensation unit 412-1 to the phase compensation unit 412-4, they are simply referred to as “phase compensation unit 412”.

The crosstalk compensation coefficient control unit 413-1 controls the FIR filter coefficients (hereinafter, it may be simply referred to as a “filter coefficient”) of the crosstalk compensation unit 410-1 by using a reference signal known on the reception side. As similar to this, the crosstalk compensation coefficient control unit 413-2 controls the filter coefficients of the crosstalk compensation unit 410-2 by using a reference signal known on the reception side. Hereinafter, in a case where it is not necessary to distinguish and describe the crosstalk compensation coefficient control unit 413-1 and the crosstalk compensation coefficient control unit 413-2, they are simply referred to as “crosstalk compensation coefficient control unit 413”. For example, a least mean square (LMS) algorithm described in Non Patent Literature 7 can be used for the control of the filter coefficient of the crosstalk compensation unit 410 by the crosstalk compensation coefficient control unit 413.

As similar to this, the waveform distortion compensation coefficient control unit 414-1 controls the filter coefficients of the waveform distortion compensation unit 411-1 by using a reference signal known on the reception side. As similar to this, the waveform distortion compensation coefficient control unit 414-2 controls the filter coefficients of the waveform distortion compensation unit 411-2 by using a reference signal known on the reception side. Hereinafter, in a case where it is not necessary to distinguish and describe the waveform distortion compensation coefficient control unit 414-1 and the waveform distortion compensation coefficient control unit 414-2, they are simply referred to as “waveform distortion compensation coefficient control unit 414”. As similar to the control of the filter coefficients of the crosstalk compensation unit 410, for example, the LMS algorithm described in Non Patent Literature 7 can be used for the control of the filter coefficients of the waveform distortion compensation unit 411 by the waveform distortion compensation coefficient control unit 414.

The reference signal processing unit 415-1 transforms a reference signal known on the reception side used for updating the filter coefficient of the waveform distortion compensation unit 411-1 in the preceding stage and updating the compensation amount by the phase compensation unit 412-1 and the phase compensation unit 412-3 by affine transformation using the filter coefficient of the crosstalk compensation unit 410-1 to obtain a new reference signal. As similar to this, the reference signal processing unit 415-2 transforms a reference signal known on the reception side used for updating the filter coefficient of the waveform distortion compensation unit 411-2 and updating the compensation amount by the phase compensation unit 412-2 and the phase compensation unit 412-4 by affine transformation using the filter coefficient of the crosstalk compensation unit 410-2 to obtain a new reference signal.

The transformation processing by the reference signal processing unit 415-1 generates a reference signal (after transformation) in which waveform distortion (that is, waveform distortion that can be compensated only by the crosstalk compensation unit 410-1) that cannot be compensated by the waveform distortion compensation unit 411-1 is taken into consideration. The transformed reference signal is used to control the filter coefficient of the waveform distortion compensation unit 411-1 by the LMS algorithm by the waveform distortion compensation coefficient control unit 414-1. As similar to this, the transformation processing by the reference signal processing unit 415-2 generates a reference signal (after transformation) in which waveform distortion (that is, waveform distortion that can be compensated only by the crosstalk compensation unit 410-2) that cannot be compensated by the waveform distortion compensation unit 411-2 is taken into consideration. The transformed reference signal is used to control the filter coefficient of the waveform distortion compensation unit 411-2 by the LMS algorithm by the waveform distortion compensation coefficient control unit 414-1.

The transformed reference signal generated by the reference signal processing unit 415-1 is used for calculating the compensation amount of the phase compensation unit 412-1 and the phase compensation unit 412-3 arranged in the preceding stage of the crosstalk compensation unit 410-1. As similar to this, the transformed reference signal generated by the reference signal processing unit 415-2 is used for calculating the compensation amount of the phase compensation unit 412-2 and the phase compensation unit 412-4 arranged in the preceding stage of the crosstalk compensation unit 410-2. Hereinafter, in a case where it is not necessary to distinguish and describe the reference signal processing unit 415-1 and the reference signal processing unit 415-2, they are simply referred to as “reference signal processing unit 415”.

### [Processing Flow]

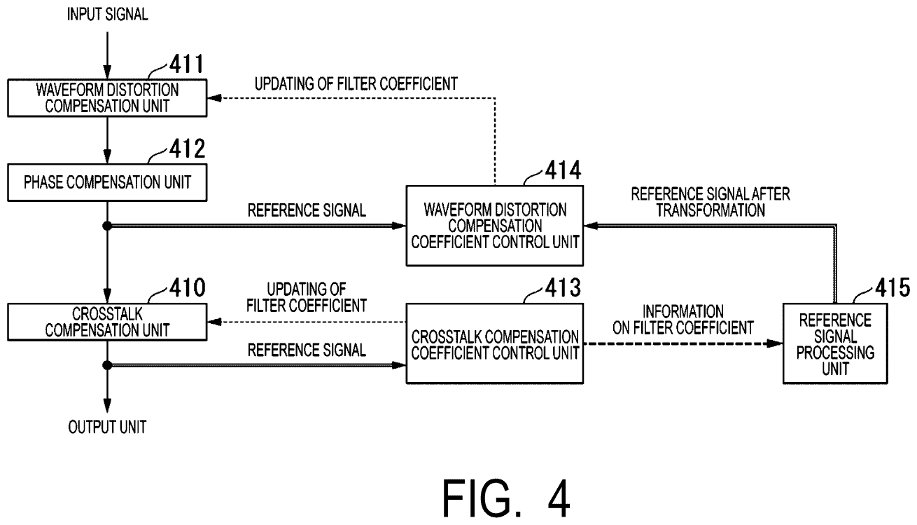

An example of a flow of signal processing by the digital signal processing unit 41 will be described below. FIG. 4 is a flowchart of multi-carrier signal waveform equalization processing by the digital signal processing unit 41 according to the first embodiment of the present invention. The waveform distortion compensation unit 411 acquires an input signal (here, a reference signal known at the reception side). The waveform distortion compensation unit 411 compensates for linear distortion other than distortion to be compensated by the crosstalk compensation unit 410. The waveform distortion compensation unit 411 outputs the reference signal to the phase compensation unit 412.

The phase compensation unit 412 acquires the reference signal output from the waveform distortion compensation unit 411. The phase compensation unit 412 compensates for the phase rotation of the signal using the acquired reference signal. The phase compensation unit 412 outputs the reference signal to the crosstalk compensation unit 410 and the waveform distortion compensation coefficient control unit 414.

The waveform distortion compensation coefficient control unit 414 acquires the reference signal output from the phase compensation unit 412. The waveform distortion compensation coefficient control unit 414 updates (controls) the filter coefficient of the waveform distortion compensation unit 411 by the LMS algorithm using the acquired reference signal.

The crosstalk compensation unit 410 acquires the reference signal output from the phase compensation unit 412. The crosstalk compensation unit 410 compensates for crosstalk between signals superimposed on each of the two subcarriers. The crosstalk compensation unit 410 outputs the reference signal to the crosstalk compensation coefficient control unit 413, and outputs the reference signal as an output signal.

The crosstalk compensation coefficient control unit 413 acquires the reference signal output from the crosstalk compensation unit 410. The crosstalk compensation coefficient control unit 413 updates (controls) the filter coefficient of the crosstalk compensation unit 410 by the LMS algorithm using the acquired reference signal. In addition, the crosstalk compensation coefficient control unit 413 outputs information indicating the updated filter coefficient to the reference signal processing unit 415.

The reference signal processing unit 415 acquires information indicating the filter coefficient of the updated crosstalk compensation unit 410 output from the crosstalk compensation coefficient control unit 413. The reference signal processing unit 415 transforms a reference signal known on the reception side used for updating the filter coefficient of the waveform distortion compensation unit 411 in the preceding stage and updating the compensation amount by the phase compensation unit 412 by affine transformation using the updated filter coefficient of the crosstalk compensation unit 410 to obtain a new reference signal. The reference signal processing unit 415 outputs the transformed reference signal to the waveform distortion compensation coefficient control unit 414.

The waveform distortion compensation coefficient control unit 414 acquires the transformed reference signal output from the reference signal processing unit 415. The waveform distortion compensation coefficient control unit 414 updates (controls) the filter coefficient of the waveform distortion compensation unit 411 by the LMS algorithm using the acquired transformed reference signal.

As described above, the transformation processing by the reference signal by the reference signal processing unit 415 generates a reference signal (after transformation) in which waveform distortion (that is, waveform distortion that can be compensated only by the crosstalk compensation unit 410) that cannot be compensated by the waveform distortion compensation unit 411 is taken into consideration. Then, the transformed reference signal is reflected in the control of the filter coefficient by the LMS algorithm of the waveform distortion compensation coefficient control unit 414.

With such a configuration, according to the multi-carrier signal waveform equalization circuit included in the digital signal processing unit 41 in the first embodiment, overall optimization of both the waveform distortion compensation unit 411 and the crosstalk compensation unit 410 is achieved, and waveform equalization performance and signal quality are improved.

### Second Embodiment

Hereinafter, a second embodiment of the present invention will be described. As similar to the above-mentioned first embodiment, a multi-carrier signal waveform equalization circuit in the second embodiment described below is a circuit that performs digital signal processing on a reception signal transformed from an optical signal into an electrical signal by coherent detection. The optical signal is transformed into a digital modulation signal by phase modulation or quadrature amplitude modulation in a transmission device as a communication partner, then divided into a plurality of carrier waves, superimposed on local oscillation laser, and then transmitted to a reception device. The multi-carrier signal waveform equalization circuit is a circuit mounted on the reception device.

The multi-carrier signal waveform equalization circuit according to the second embodiment includes a crosstalk compensation unit that compensates for crosstalk between signals superimposed on each of a plurality of carrier waves obtained from a reception signal for each polarization (that is, for each of the X-polarized wave and the Y-polarized wave).

With such a configuration, the multi-carrier signal waveform equalization circuit in the second embodiment can enable effective equalization for crosstalk between subcarriers in a multi-carrier signal. As a result, the multi-carrier signal waveform equalization circuit according to the second embodiment can achieve signal processing with higher accuracy even in an environment where imperfections of analog devices and laser phase noise/frequency errors exist in communication using multi-carrier signals.

Since an overall configuration of an optical communication system in the second embodiment is similar to the overall configuration of the optical communication system 1 in the first embodiment illustrated in FIG. 1 described above, the description thereof will be omitted. [Configuration of Digital Signal Processing Unit] Hereinafter, the configuration of a digital signal processing unit 41a according to the second embodiment will be described. As similar to the above-mentioned first embodiment, in the second embodiment, as an example, a case will be described in which communication is performed using a multi-carrier signal having two subcarriers obtained by polarization multiplexing.

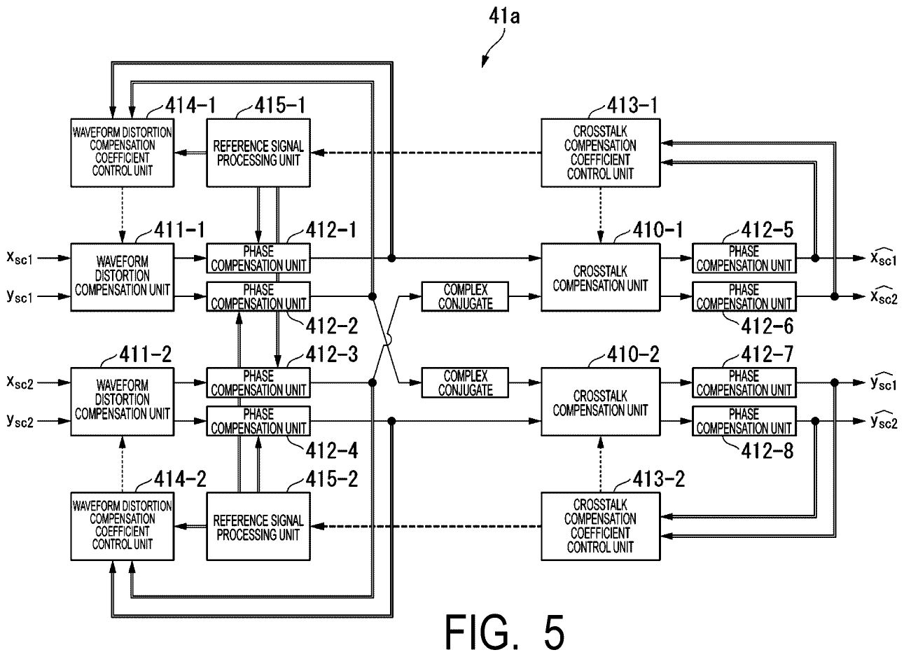

FIG. 5 is a block diagram illustrating the configuration of the digital signal processing unit 41a according to the second embodiment of the present invention. As illustrated in FIG. 5, the digital signal processing unit 41a outputs four signals of (x_{sc})\hat{ }, (y_{sc1})\hat{ }, (x_{sc2})\hat{ }, and (y_{sc2})\hat{ } in response to inputs of four signals of x_{sc1}, y_{sc1}, x_{sc2}, and y_{sc2}. The signal represented by each of these variables is as described in the above-mentioned first embodiment.

As illustrated in FIG. 5, the digital signal processing unit 41a includes a crosstalk compensation unit 410-1 and a crosstalk compensation unit 410-2, a waveform distortion compensation unit 411-1 and a waveform distortion compensation unit 411-2, a phase compensation unit 412-1 to a phase compensation unit 412-4, a phase compensation unit 412-5 to a phase compensation unit 412-8, a crosstalk compensation coefficient control unit 413-1 and a crosstalk compensation coefficient control unit 413-2, a waveform distortion compensation coefficient control unit 414-1 and a waveform distortion compensation coefficient control unit 414-2, a reference signal processing unit 415-1, and a reference signal processing unit 415-2.

As illustrated in FIG. 5, the configuration of the digital signal processing unit 41a in the second embodiment is different from the configuration of the digital signal processing unit 41 in the above-mentioned first embodiment (illustrated in FIG. 2) in that the phase compensation unit 412-5 to the phase compensation unit 412-8 are further included.

As described above, the phase compensation unit 412-1 to the phase compensation unit 412-4 compensate for the phase rotation of the signal using the reference signal known on the reception side. On the other hand, the phase compensation unit 412-5 to the phase compensation unit 412-8 compensate for the phase rotation of the signal on the basis of the hard decision results of the symbols input to the phase compensation unit 412-5 to the phase compensation unit 412-8 without using the reference signal known on the reception side.

The phase compensation unit 412-1 and the phase compensation unit 412-3 arranged in the preceding stage of the crosstalk compensation unit 410-1 operate in a state including distortion to be compensated by the crosstalk compensation unit 410-1. As similar to this, the phase compensation unit 412-2 and the phase compensation unit 412-4 arranged in the preceding stage of the crosstalk compensation unit 410-2 operate in a state including distortion to be compensated by the crosstalk compensation unit 410-2. Therefore, distortion remains in principle in the output signals of the phase compensation unit 412-1 to the phase compensation unit 412-4.

On the other hand, the phase compensation unit 412-5 and the phase compensation unit 412-6 are also arranged in the subsequent stage of the crosstalk compensation unit 410-1, and the phase compensation unit 412-7 and the phase compensation unit 412-8 are also arranged in the subsequent stage of the crosstalk compensation unit 410-2, so that the digital signal processing unit 41a according to the second embodiment can compensate for the residual distortion and further improve the waveform equalization performance and the signal quality.

As similar to the above-mentioned first embodiment, the transformation processing by the reference signal by the reference signal processing unit 415 generates a reference signal (after transformation) in which waveform distortion (that is, waveform distortion that can be compensated only by the crosstalk compensation unit 410) that cannot be compensated by the waveform distortion compensation unit 411 is taken into consideration. Then, the transformed reference signal is reflected in the control of the filter coefficient by the LMS algorithm of the waveform distortion compensation coefficient control unit 414.

With such a configuration, according to the multi-carrier signal waveform equalization circuit included in the digital signal processing unit 41 in the second embodiment, overall optimization of both the waveform distortion compensation unit 411 and the crosstalk compensation unit 410 is achieved, and waveform equalization performance and signal quality are improved.

### Example

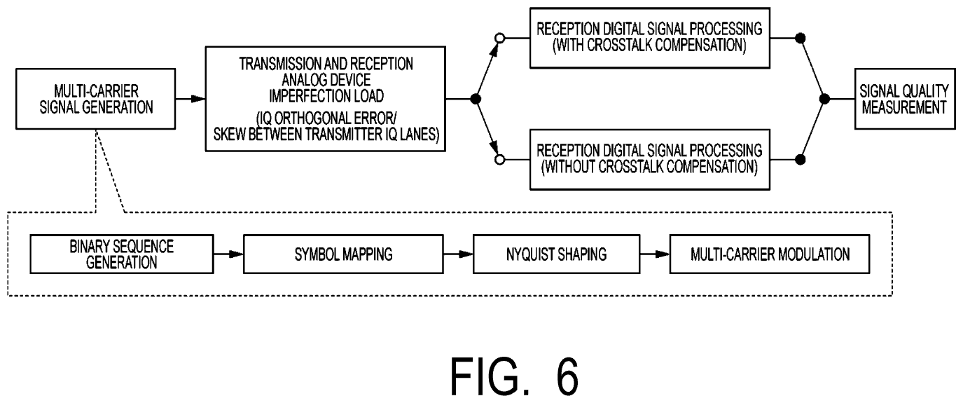

Hereinafter, a computer simulation performed to evaluate the implementation effect of the present invention will be described. FIG. 6 is a diagram illustrating a procedure of a computer simulation performed.

As illustrated in FIG. 6, computer simulation was performed in the order of multi-carrier signal generation, transmission/reception analog device imperfection load, received digital signal processing with crosstalk compensation, reception digital signal processing without crosstalk compensation, and signal quality measurement.

As illustrated in FIG. 6, in the multi-carrier signal generation, processing was performed in the order of binary sequence generation, symbol mapping, Nyquist shaping, and multi-carrier modulation. In the binary sequence generation processing, a bit string of a binary sequence is generated. In the symbol mapping processing, the bit string of the binary sequence is transformed into the QAM signal on the basis of the mapping rule. In the Nyquist shaping processing, band narrowing processing using a Nyquist filter was performed. In the multi-carrier modulation processing, transformation into signals of a plurality of carriers was performed.

In the reception digital signal processing with the crosstalk compensation, the operation of the crosstalk compensation coefficient control unit is turned on, and in the reception digital signal processing without the crosstalk compensation, the operation of the crosstalk compensation coefficient control unit is turned off. In the signal quality measurement, evaluation was performed by calculating a Q factor on the basis of the transmitted binary sequence (sequence of “0” and “1”) and a binary sequence restored from an input signal to a signal quality measurement unit (not illustrated).

The quality (Q) factor here indicates optical signal quality. The amplitudes of “0” and “1” of the binary signal vary due to noise or the like, but the Q factor is a value defined from a difference between the magnitude (standard deviation) of the spread and the average amplitude. For example, when the quality deteriorates, the Q factor decreases because the amplitude variation of the signal increases or the difference in average amplitude decreases.

In general, the most accurate signal monitoring is bit error rate (BER) monitoring. However, BER monitoring has disadvantages such as difficulty in monitoring during service operation, a long measurement time when signal quality is preferable, and dependence on a bit rate and a signal format. Therefore, how to monitor the optical signal quality without depending on the bit rate or the signal format (transparent) and more accurately in a short time without hindering communication is a problem in studying the optical signal monitoring method. By using the method of measuring the Q factor, many of the above problems are solved.

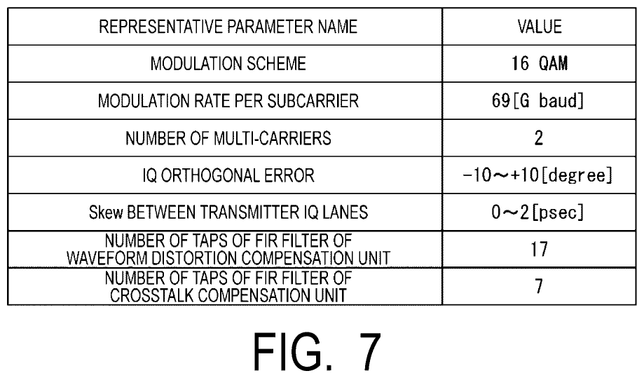

FIG. 7 is a diagram illustrating representative parameters and values thereof used in the computer simulation performed. As illustrated in FIG. 7, 16 QAM is used as the modulation scheme, the modulation rate per subcarrier is set to 69 [G boud], the number of multi-carriers is set to 2, the IQ orthogonal error is set to −10 to +10 [degree], the skew between the transmitter IQ lanes is set to 0 to 2 [psec], the number of taps of the FIR filter of the waveform distortion compensation unit is set to 17, and the number of taps of the FIR filter of the crosstalk compensation unit is set to 7.

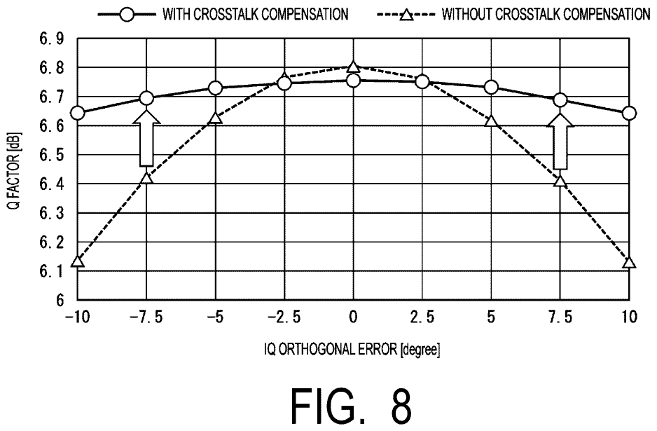

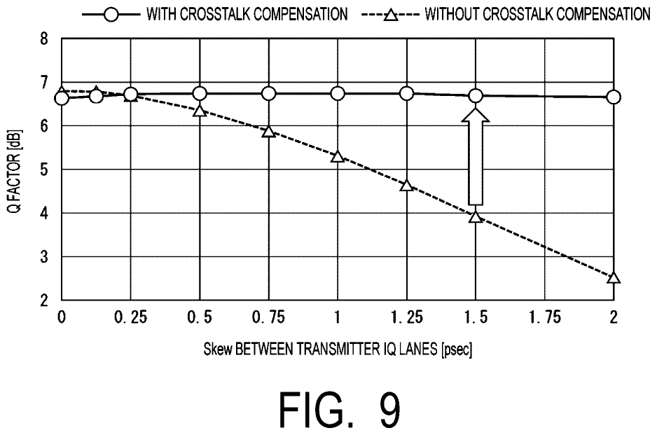

FIGS. 8 and 9 are diagrams illustrating a result of the computer simulation performed. FIG. 8 illustrates a Q factor for each IQ orthogonal error, and FIG. 9 illustrates a Q factor for each skew between the transmitter IQ lanes.

As illustrated in FIG. 8, for example, the Q factor when the IQ orthogonal error is −7.5 [degree] and the Q factor when the IQ orthogonal error is 7.5 [degree] are approximately 6.4 [dB] in a case where there is no crosstalk compensation, and are approximately 6.7 [dB] in a case where there is the crosstalk compensation according to the present invention. Therefore, the Q factor when the IQ orthogonal error is −7.5 [degree] increased by approximately 0.3 [dB] due to the crosstalk compensation according to the present invention.

As illustrated in FIG. 9, for example, the Q factor when the skew between transmitter lanes is 1.5 [psec] is approximately 4 [dB] in a case where there is no crosstalk compensation, whereas it is approximately 6.8 [dB] in a case where there is the crosstalk compensation according to the present invention. Thus, the Q factor when the skew between transmitter lanes was 1.5 [psec] increased by approximately 2.8 [dB] due to the crosstalk compensation according to the present invention.

Thus, the results of the computer simulation of the present invention illustrated in FIGS. 8 and 9 illustrate that the crosstalk compensation according to the present invention improves the signal quality (Q factor).

According to the above-described embodiments, the multi-carrier signal waveform equalization circuit includes an acquisition unit (an acquirer) and a crosstalk compensation unit (a crosstalk compensator). For example, the multi-carrier signal waveform equalization circuit is a circuit constituting the digital signal processing unit 41 in the embodiments, the acquisition unit is the waveform distortion compensation unit 411 in the embodiments, and the crosstalk compensation unit is the crosstalk compensation unit 410 in the embodiments.

The acquisition unit acquires an optical signal that is transformed into a digital modulation signal by phase modulation or quadrature amplitude modulation, then divided into a plurality of carrier waves, superimposed on local oscillation laser, and then transmitted from the transmission unit (the transmitter), the electrical signal being obtained by transforming the optical signal by coherent detection. For example, the plurality of carrier waves are a subcarrier #1 and a subcarrier #2 in the embodiments, and the transmission unit is the optical transmission unit 2 in the embodiments.

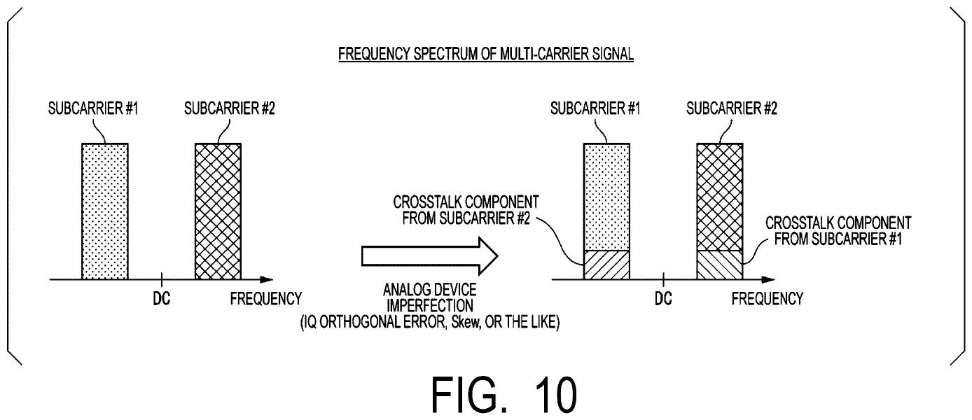

The crosstalk compensation unit described above compensates for crosstalk between a plurality of signals superimposed on a plurality of carrier waves obtained from the acquired electrical signal. For example, the crosstalk between the plurality of signals is the crosstalk component from subcarrier #2 superimposed on subcarrier #1 and the crosstalk component from subcarrier #1 superimposed on subcarrier #2 (illustrated in FIG. 10) in the embodiments. In the multi-carrier signal waveform equalization circuit described above, the crosstalk compensation unit includes a digital filter. For example, the digital filter is a 2×2 FIR filter (illustrated in FIG. 3) in the embodiments.

The multi-carrier signal waveform equalization circuit further includes a phase compensation unit (a phase compensator). For example, the phase compensation unit is the phase compensation unit 412 in the embodiments.

The phase compensation unit is arranged in a preceding stage of the crosstalk compensation unit or in both of a preceding stage and a subsequent stage of the crosstalk compensation unit, and compensates for phase rotation of a signal. For example, the phase compensation units arranged in the preceding stage of the crosstalk compensation unit are the phase compensation unit 412-1 to the phase compensation unit 412-4 in the embodiments, the phase compensation units arranged in the subsequent stage of the crosstalk compensation unit are the phase compensation unit 412-5 to the phase compensation unit 412-8 in the embodiments, the transmission unit is the optical transmission unit 2 in the embodiments, and the reception unit is the optical reception unit 4 in the embodiments.

The multi-carrier signal waveform equalization circuit further includes a waveform distortion compensation unit (a waveform distortion compensator). For example, the waveform distortion compensation unit is the waveform distortion compensation unit 411 in the embodiments. The waveform distortion compensation unit is arranged in a preceding stage of the crosstalk compensation unit, and compensates for linear distortion other than distortion to be compensated by the crosstalk compensation unit.

In the multi-carrier signal waveform equalization circuit described above, the waveform distortion compensation unit includes a digital filter. For example, the digital filter is a 2×2 FIR filter (illustrated in FIG. 3) in the embodiments.

The multi-carrier signal waveform equalization circuit further includes a reference signal processing unit (a reference signal processor). For example, the reference signal processing unit is the reference signal processing unit 415 in the embodiments.

The reference signal processing unit transforms the reference signal known on the reception side used for updating the filter coefficient of the digital filter constituting the waveform distortion compensation unit into a new reference signal by affine transformation using the filter coefficient of the digital filter of the crosstalk compensation unit, and updates the filter coefficient of the digital filter constituting the waveform distortion compensation unit with the transformed reference signal.

The multi-carrier signal waveform equalization circuit further includes a reference signal processing unit. The reference signal processing unit transforms the reference signal known on the reception side used to update the compensation amount of the phase compensation unit arranged in the preceding stage of the crosstalk compensation unit into a new reference signal by affine transformation using the filter coefficient of the digital filter of the crosstalk compensation unit, and causes the compensation amount of the phase compensation unit to be calculated by the transformed reference signal.

A part of the digital signal processing unit 41 and the digital signal processing unit 41a in the above-described embodiments may be implemented by a computer. In that case, a program for implementing the functions may be recorded in a computer-readable recording medium, and the functions may be implemented by loading the program recorded in this recording medium to a computer system, and executing the program. Note that, the “computer system” referred to herein includes an OS and hardware such as peripheral equipment. In addition, the “computer-readable recording medium” refers to a portable medium such as a flexible disk, a magneto-optical disc, a ROM, or a CD-ROM or a storage device such as a hard disk included in the computer system.

Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program described above may be for implementing a part of the function described above, may be implemented in a combination with a program already recorded in a computer system, or may be implemented with a programmable logic device such as a field programmable gate array (FPGA).

Although the embodiments of the present invention have been described in detail with reference to the drawings, the specific configuration is not limited to the embodiments and includes design and the like within the scope of the present invention.

### REFERENCE SIGNS LIST

1 Optical communication system
2 Optical transmission unit
3 Optical transmission line
4 Optical reception unit
20 Electrical signal generation unit
21 Optical signal generation unit
30 Optical fiber
31 Optical amplifier
40 Coherent optical reception unit
41, 41a Digital signal processing unit
410, 410-1, 410-2 Crosstalk compensation unit
411-1, 411-2 Compensation unit
412-1 to 412-8 Phase compensation unit
413-1, 413-2 Crosstalk compensation coefficient control unit
414-1, 414-2 Compensation coefficient control unit
415-1, 415-2 Reference signal processing unit
4101 FIR filter

1. A multi-carrier signal waveform equalization circuit comprising:
an acquirer that acquires an electrical signal obtained by transforming an optical signal by coherent detection, the optical signal obtained by transformation into a digital modulation signal by phase modulation or quadrature amplitude modulation, and then the digital modulation signal being divided into a plurality of carrier waves, superimposed on local oscillation laser, and then transmitted from a transmitter; and
a crosstalk compensator that compensates for crosstalk between a plurality of signals superimposed on each of the plurality of carrier waves obtained from the electrical signal that has been acquired.

2. The multi-carrier signal waveform equalization circuit according to claim 1,
wherein the crosstalk compensator includes a digital filter.

3. The multi-carrier signal waveform equalization circuit according to claim 2, further comprising
a phase compensator that is arranged in a preceding stage of the crosstalk compensator or in both of a preceding stage and a subsequent stage of the crosstalk compensator, and compensates for phase rotation of a signal.

4. The multi-carrier signal waveform equalization circuit according to claim 2, further comprising
a waveform distortion compensator that is arranged in a preceding stage of the crosstalk compensator, and compensates for linear distortion other than distortion to be compensated by the crosstalk compensator.

5. The multi-carrier signal waveform equalization circuit according to claim 4,
wherein the waveform distortion compensator includes a digital filter.

6. The multi-carrier signal waveform equalization circuit according to claim 5, further comprising
a reference signal processor that transforms a reference signal known on a reception side used for updating a filter coefficient of the digital filter constituting the waveform distortion compensator into a new reference signal by affine transformation using the filter coefficient of the digital filter of the crosstalk compensator, and updates the filter coefficient of the digital filter constituting the waveform distortion compensator with the reference signal after transformation.

7. The multi-carrier signal waveform equalization circuit according to claim 3, further comprising
a reference signal processor that transforms a reference signal known on a reception side used to update a compensation amount of the phase compensator arranged in the preceding stage of the crosstalk compensator into a new reference signal by affine transformation using a filter coefficient of the digital filter of the crosstalk compensator, and causes the compensation amount of the phase compensator to be calculated by the reference signal after transformation.

8. A multi-carrier signal waveform equalization method comprising:
acquiring an electrical signal obtained by transforming an optical signal by coherent detection, the optical signal obtained by transformation into a digital modulation signal by phase modulation or quadrature amplitude modulation, and then the digital modulation signal being divided into a plurality of carrier waves, superimposed on local oscillation laser, and then transmitted from a transmitter; and
compensating for crosstalk between a plurality of signals superimposed on each of the plurality of carrier waves obtained from the electrical signal that has been acquired.
